(19) United States
(12) Patent Application Publication
(10) Pub. No.: US 2012/0281151 A1
(43) Pub. Date: Nov. 8, 2012

(54) LIGHTING DEVICE, DISPLAY DEVICE AND TELEVISION RECEIVER

(75) Inventor: Masakazu Abe, Osaka-shi (JP)

(73) Assignee: SHARP KABUSHIKI KAISHA, Osaka-shi, Osaka (JP)

(21) Appl. No.: 13/521,449

(22) PCT Filed: Jan. 11, 2011
(86) PCT No.: PCT/JP2011/050256

§ 371 Date: Jul. 11, 2012

(30) Foreign Application Priority Data
Jan. 29, 2010 (JP) 2010-018895

(51) Int. Cl. F21V 8/00; G02F 1/13357; H04N 5/66; F21V 7/04

(52) U.S. Cl. 348/739; 362/611; 362/609; 362/602; 349/65; 348/E05.133

(57) ABSTRACT

A lighting device is provided in which a distance between a light guide plate and a light source can be held constant, and thus an optical design thereof can be maintained. A backlight unit 24 according to the present invention includes an LED board 30, an LED 28, a light guide plate 20 having a light entrance surface 20a, and a spacer member 25. The spacer member 25 includes a first restriction portion 25a and a second restriction portion 25b. The first restriction portion 25a extends between the LED board 28 and a side edge of the light guide plate 20. The second restriction portion 25b extends from the first restriction portion 25a in a direction toward a side opposite to the light entrance surface 20a. The first and second restriction portion 25a, 25b, respectively, restricts displacements of the light guide plate 20 in a planar direction toward the LED light source 28 and in a planar direction away from the LED 28.

### TECHNICAL FIELD

The present invention relates to a lighting device, a display device and a television receiver.

### BACKGROUND ART

In recent years, a display element of an image display device such as a television receiver has shifted from a conventional CRT display device to a thin display device using a thin display element such as a liquid crystal panel and a plasma display panel. This enables the image display device to have a reduced thickness. A liquid crystal panel used for a liquid crystal display device does not emit light, and thus a backlight unit is required as a separate lighting device.

Patent Document 1 discloses a backlight unit including a light source board, light sources arranged on a surface of the light source board, a light guide plate having a side surface serving as a light entrance surface, and a transparent spacer member provided between the light guide plate and the light sources. The light guide plate guides the light emitted from the light source. In this backlight unit, when the light guide plate is expanded, displacement of the light guide plate in a planar direction toward the light source is restricted by the spacer member.

### RELATED ART DOCUMENT

### Patent Document

Patent Document 1: Japanese Unexamined Patent Publication No. 2008-97877

### Problem to be Solved by the Invention

In the backlight unit disclosed in Patent Document 1, when the light guide plate is contracted, displacement of the light guide plate in a planar direction away from the light source is not restricted. Accordingly, a distance between the light guide plate and the light source may not remain within a certain range, and thus the optical design of the backlight unit cannot be maintained.

### DISCLOSURE OF THE PRESENT INVENTION

The present invention was made in view of the above circumstances. It is an object of the present invention to provide a lighting device in which a distance between the light guide plate and the light source can remain within a certain range, and thus the optical design thereof can be maintained, even if the light source is expanded or contracted.

### Means for Solving the Problem

The technology disclosed herein relates to a lighting device including: a light source board; a light source mounted on a surface of the light source board; a light guide plate having a light entrance surface, a light exit surface, and an opposite surface, the light entrance surface being arranged on a side of the light guide plate to face the light source such that light emitted from the light source enters the light entrance surface and exits through the light exit surface, the light exit surface being a plate surface of the light guide plate, the opposite surface being opposite to the light exit surface; and a spacer member including a first restriction portion and a second restriction portion, the first restriction portion extending between the light source board and a side edge of the light guide plate and configured to restrict displacement of the light guide plate in a planar direction toward the light source, and the second restriction portion extending from the first restriction portion along the light exit surface and the opposite surface in a direction toward a side opposite to the light entrance surface and configured to restrict displacement of the light guide plate in a planar direction away from the light source, whereby the spacer member holds a distance between the light guide plate and the light source board.

In the lighting device described herein, if the light guide plate is expanded, the first restriction portion of the spacer member restricts displacement of the light guide plate in a planar direction toward the light source. Further, if the light guide plate is contracted, the second restriction portion of the spacer member restricts displacement of the light guide plate in a planar direction away from the light source. Accordingly, if the light guide plate is expanded by heat or contracted, the distance between the light guide plate and the light source can be held constant. Thus, the optical design of the lighting device can be maintained.

In the above lighting device, the first restriction portion may include a first contact portion that is in abutting contact with the light entrance surface of the light guide plate, and the second restriction portion may include pointed projections each projecting toward the light exit surface and the opposite surface of the light guide plate. The first contact portion may be configured to restrict the displacement of the light guide plate in a planar direction toward the light source. The projections may be caught on the light exit surface and the opposite surface of the light guide plate. With this configuration, the planar displacement of the light guide plate can be more properly restricted.

In the above lighting device, the first restriction portion may include a first contact portion that is in abutting contact with the light entrance surface of the light guide plate. The first contact portion may be configured to restrict displacement of the light guide plate in a planar direction toward the light source, and the second restriction portion may be in abutting contact with the light exit surface and the opposite surface of the light guide plate so as to sandwich the light guide plate in a thickness direction. With this configuration, the planar displacement of the light guide plate can be more properly restricted.

In the above lighting device, the first restriction portion may further include a second contact portion that is in abutting contact with the surface of the light source board. With this configuration, the second contact portion positions the surface of the light source board. Thus, warp and lifting up of the light source board by heat is less likely to occur.

The above lighting device may further include: a housing member configured to house at least the light source board and the light guide plate; and an elastic member arranged between the light source board and the housing member. The elastic member may have Young's modulus smaller than that of the spacer member. If the light guide plate is expanded toward the light source, the expansion of the light guide plate is absorbed by the elastic member through the spacer member. Accordingly, the expansion of the light guide plate can be absorbed and the displacement of the light guide plate toward the light source can be restricted at the same time.

In the above lighting device, the elastic member may have thermal conductivity. With this configuration, heat generated around the light source board can be effectively dissipated.

In the above lighting device, the spacer member may include a third restriction portion extending from the first restriction portion to a surface of the elastic member. The third restriction portion may include a third contact portion that is in abutting contact with the surface of the elastic member. With this configuration, if the light guide plate is expanded, the expansion of the light guide plate can be absorbed by the elastic member without being absorbed by the light source board. Accordingly, the expansion of the light guide plate can be effectively absorbed by the elastic member.

In the above lighting device, the spacer member may have a linear expansion coefficient smaller than that of the light guide plate. With this configuration, thermal expansion coefficient of the spacer member is smaller than that of the light guide plate. Thus, the spacer member can effectively restrict displacement of the light guide plate in a direction perpendicular to the entrance surface thereof.

In the above lighting device, the light source board may be a part of the spacer member. With this configuration, the spacer member and the light source board can be molded integrally.

In the above lighting device, a reflector may be further provided. The light entrance surface may have an elongated shape, and the reflector may be arranged between the light source and the light guide plate so as to extend along a long-side direction of the light entrance surface. Further, the spacer member may be capable of reflecting light. With this configuration, the light emitted from the light source and scattered outside the light guide plate can enter the light guide plate by the reflector and the spacer member. This improves the light entrance efficiency of the light entering the light guide plate from the light source.

The technology disclosed herein may be embodied as a display device including a display panel configured to display by using light provided by the above lighting device. Further, a display device including a liquid crystal panel using liquid crystals as the display panel has novelty and utility. Furthermore, a television receiver including the above display device has novelty and utility. The above display device and television can have an increased display area.

### Advantageous Effect of the Invention

According to the technology disclosed herein, even in case that the light guide plate of the lighting device is expanded or retracted, the distance between the light guide plate and the light source can be held constant, and thus, the optical design of the backlight unit can be maintained.

### BRIEF DESCRIPTION OF THE DRAWINGS

FIG. 1 is an exploded perspective view of a television receiver TV according to the first embodiment of the present invention;

FIG. 2 is an exploded perspective view of a liquid crystal display device 10;

FIG. 3 is a cross-sectional view of the liquid crystal display device 10;

FIG. 4 is a magnified cross-sectional view of a spacer member 25;

FIG. 5 is a magnified perspective view of a part of a backlight unit 24;

FIG. 6 is an exploded perspective view of a liquid crystal display device 110 according to the second embodiment;

FIG. 7 is a cross-sectional view of a liquid crystal display device 110; and

FIG. 8 is a magnified cross-sectional view of a spacer member 125.

### MODE FOR CARRYING OUT THE INVENTION

### First Embodiment

Embodiments according to the present invention will be described with reference to the drawings. An X-axis, a Y-axis and a Z-axis are described in a part of the drawings. The axes in each drawing correspond to the respective axes in other drawings. The Y-axis direction and the X-axis direction, respectively, correspond to the vertical direction and the horizontal direction. The description of upper and lower side is based on the vertical direction unless otherwise specified.

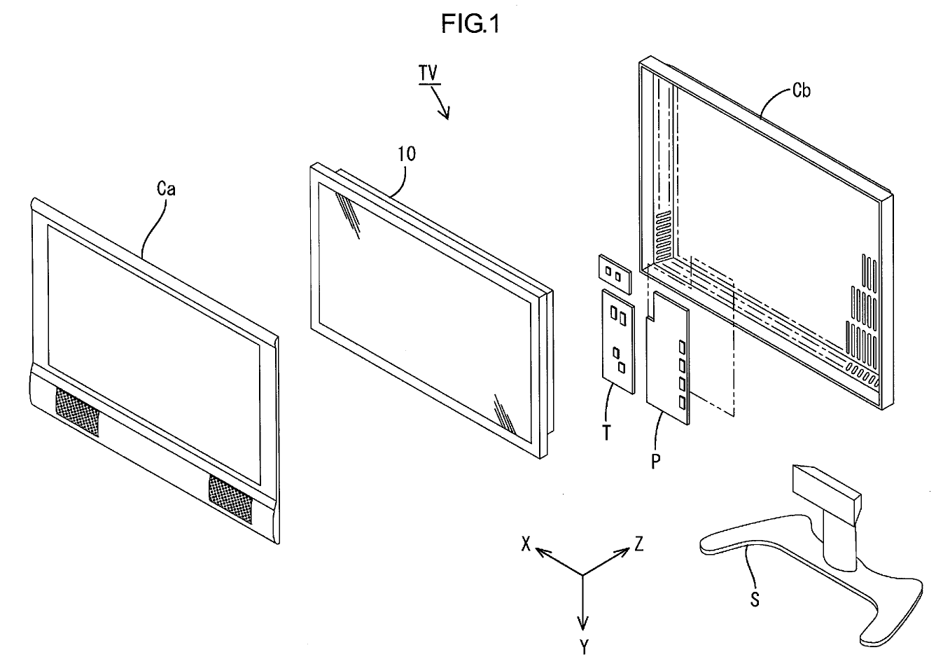

FIG. 1 illustrates a television receiver TV according to the present embodiment in an exploded perspective view. As illustrated in FIG. 1, the television receiver TV includes a liquid crystal display device 10, front and back cabinets Ca and Cb, a power supply P, a tuner T, and a stand S. The front and back cabinets Ca and Cb sandwich, and thus house, the liquid crystal display device 10.

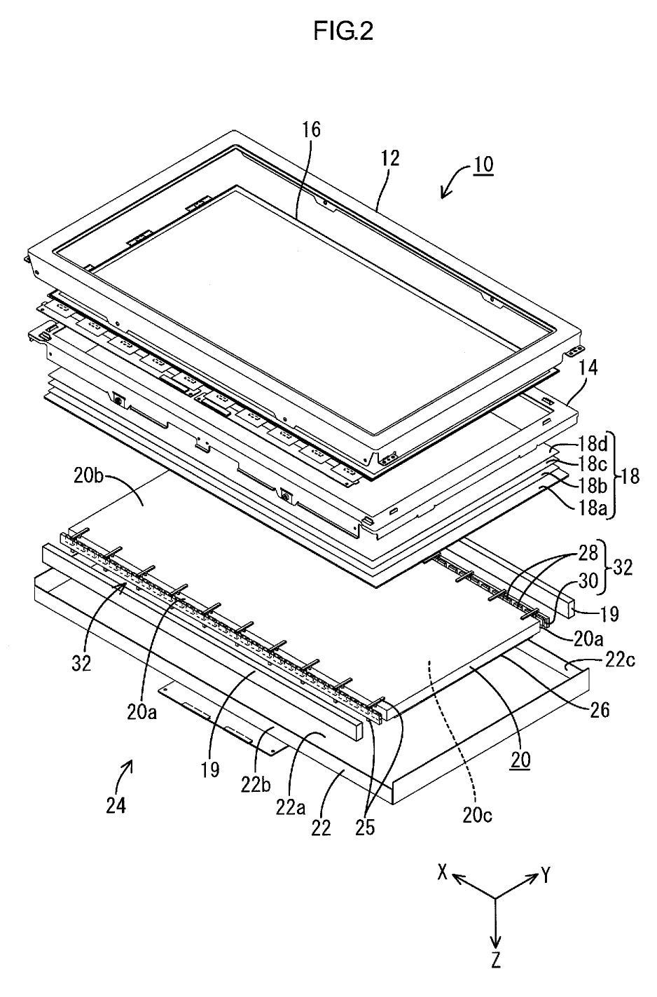

FIG. 2 illustrates the liquid crystal display device 10 in an exploded perspective view. An upper side in FIG. 2 corresponds to a front side, and a lower side therein corresponds to a rear side. As illustrated in FIG. 2, the liquid crystal display device 10 has a landscape quadrangular shape as a whole. The liquid crystal display device 10 includes a liquid crystal panel 16 as a display panel, and a backlight unit 24 as an external light source. The liquid crystal panel 16 and the backlight unit 24 are integrally held by a frame-shaped bezel 12 and the like.

Next, the liquid crystal panel 16 will be explained. The liquid crystal panel 16 is configured such that a pair of transparent (high light transmissive) glass substrates is bonded together with a predetermined gap therebetween and a liquid crystal layer (not illustrated) is sealed between the glass substrates. On one of the glass substrates, switching components (for example, TFTs) connected to source lines and gate lines which are perpendicular to each other, pixel electrodes connected to the switching components, an alignment film, and the like are provided. On the other glass substrate, color filters having color sections such as red (R), green (G), and blue (B) color sections arranged in a predetermined pattern, counter electrode, an alignment film, and the like are provided. Image data and control signals that are necessary to display an image are sent to the source lines, the gate lines, and the counter electrodes, from a drive circuit substrate, which is not illustrated. Polarizing plates (not illustrated) are arranged on outer surfaces of the glass substrates.

Next, the backlight unit 24 will be explained. As illustrated in FIG. 2, the backlight unit 24 includes a backlight chassis 22, an optical member 18, and a frame 14. The backlight chassis 22 has a substantially box-like shape with an opening on the front side (a light exit side, the liquid crystal panel 16 side). The optical member 18 is provided on the front surface (the light exit surface) of the light guide plate 20. The frame 14 has a frame shape and supports the liquid crystal panel 16 along an inner edge thereof. The backlight chassis 22 houses a pair of elastic members 19, 19, a pair of LED (Light Emitting Diode) units 32, 32, a plurality of spacer members 25, and a light guide plate 20. Each of the elastic members 19, 19 has a rectangular cross-sectional shape extending along the long-side direction of the backlight chassis 22. The pair of elastic members 19, 19 is arranged on the respective long-side outer edges of the backlight chassis 22. Each of the pair of LED units 32, 32 is arranged on an inner surface of the respective elastic members 19, 19 with the LED light sources 28 being mounted on the LED board 30. The LED units 32 are configured to emit light. The spacer members 25 are provided on the LED unit 32 at equal intervals along the long-side direction of the backlight chassis 22 so as to be arranged on upper and lower sides of the LED unit 32. The light guide plate 20 is arranged between the pair of LED units 32, 32 and configured to guide the light emitted from the LED unit 32 toward the liquid crystal panel 16. The optical member 18 is provided on a front surface of the light guide plate 20. The backlight unit 24 of the present embodiment is an edge-light type (side-light type) backlight unit in which the light guide plate 20 and the optical member 18 are arranged right behind the liquid crystal panel 16, and the LED units 32 as light sources are arranged on an end portion of the light guide plate 20.

The backlight chassis 22 is made of metal such as an aluminum material. The backlight chassis 22 includes a bottom plate 22a having a rectangular shape in a plan view, and side plates 22b, 22c each of which rises from an outer edge of the corresponding long or short sides of the bottom plate 22a toward the front side. The long side of the bottom plate 22a matches a horizontal direction (X-axis direction) and the short side thereof matches a vertical direction (Y-axis direction). In the backlight chassis 22, the light guide plate 20 is housed in a space between the pair of LED units 32, 32. On a rear surface of the bottom plate 22a, a power circuit board that supplies power to the LED unit 32 is attached, for example.

The optical member 18 includes, a diffuser plate 18a, a diffuser sheet 18b, a lens sheet 18c, and a reflection-type polarizing plate 18d arranged in this sequence from the light guide plate 20 side. The diffuser sheet 18b, the lens sheet 18c, and the reflection-type polarizing plate 18d are configured to convert the light that passed through the diffuser plate 18a into planar light. The liquid crystal panel 16 is provided on the front side of the reflection-type polarizing plate 18d. The optical member 18 is provided between the light guide plate 20 and the liquid crystal panel 16.

The LED unit 32 includes the LED board 30 and the light sources 28. The LED board 30 is made of resin and has a rectangular shape. The LED light sources 28 each emit white light. The LED light sources 28 are arranged along a line on the LED board 30. The spacer members 25 are arranged at equal intervals between the LED light sources 28. The spacer member 25 will be explained in detail later with reference to another drawing. The pair of LED units 32, 32 is each fixed to the side surface of the elastic member 19 by bonding, for example, such that the LED light sources 28 and the spacer members 25 included in one of the LED units 32, 32 face those included in the other one of the LED units 32, 32. The LED light source 28 may include a blue light emitting diode covered with a phosphor having a light emitting peak in a yellow range to emit white light. The LED light source 28 may include a blue light emitting diode covered with a phosphor having a light emitting peak in a green range and a phosphor having a light emitting peak in a red range to emit white light. The LED light source 28 may include a blue light emitting diode covered with a phosphor having a light emitting peak in a green range and a red light emitting diode to emit white light. The LED light source 28 may include a blue light emitting diode, a green light emitting diode, and a red light emitting diode to emit white light. The LED light source 28 may include an ultraviolet light emitting diode and phosphors. Specifically, the LED light source 28 may include an ultraviolet light emitting diode covered with a phosphor having a light emitting peak in a blue range, a phosphor having a light emitting peak in a green range, and a phosphor having a light emitting peak in a red range to emit white light.

The light guide plate 20 is a plate member having a rectangular shape. The light guide plate 20 is made of resin such as acrylic that has a high light transmission (high transparency). As illustrated in FIG. 2, the light guide plate 20 is arranged between the opposing LED units 32 such that a main surface (a light exit surface) 20b thereof faces the diffuser plate 18a. A reflection sheet 26 is provided on a surface of the light guide plate 20 that is opposite from the surface facing the diffuser plate 18a. The reflection sheet 26 reflects the light that leaks from the light guide plate 20, so that the leaked light enters the light guide plate 20 again. With this light guide plate 20, the light emitted from the LED unit 32 enters the light guide plate 20 through the side surface (the light entrance surface) and exits through the main surface facing the diffuser plate 18a. Thus, the liquid crystal panel 16 is irradiated with the light from the rear side thereof.

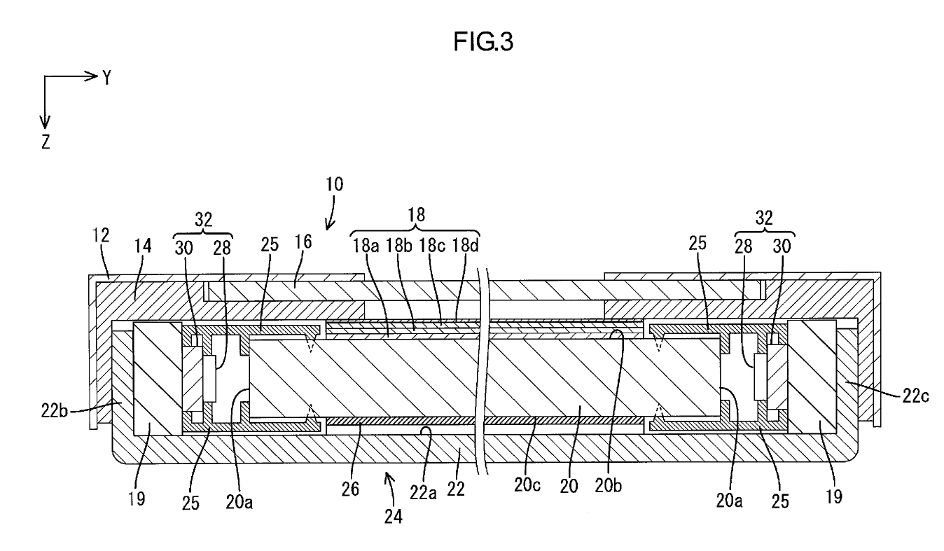

FIG. 3 illustrates the liquid crystal display device 10 in a cross-sectional view. The cross-sectional view in FIG. 3 illustrates a sectional configuration of the liquid crystal display device 10 taken along a Y-Z plane passing through the spacer member 25. As illustrated in FIG. 3, the spacer member 25 is provided so as to extend from a surface of the elastic member 19 to an end portion of the light guide plate 20. The spacer member 25 is fixed to the surface of the elastic member 19 by bonding, for example. The spacer member 25 is made of material having high dimensional stability (hard resin, metal, or ceramic, for example). The spacer member 25 has a linear expansion coefficient smaller than that of the light guide plate 20.

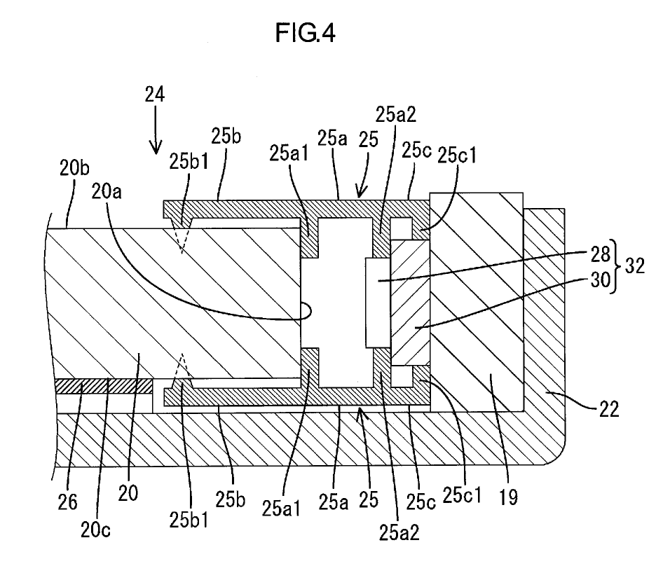

FIG. 4 illustrates the spacer member 25 in a magnified cross-sectional view. As illustrated in FIG. 4, the spacer member 25 includes a first restriction portion 25a, a second restriction portion 25b, and a third restriction portion 25c. The first restriction portion 25a extends between the LED board 30 and the light guide plate 20. The second restriction portion 25b extends from the first restriction portion 25a along the light exit surface 20b and the opposite surface 20c in a direction toward a side opposite to the light emitting surface 20a. The third restriction portion 25c extends from the first restriction portion 25a to the surface of the elastic member 19.

The first restriction portion 25a includes a first contact portion 25a1 and a second contact portion 25a2. The first contact portion 25a1 extends in the thickness direction of the light guide plate 20 with one of side surfaces thereof being in abutting contact with the light entrance surface 20a of the light guide plate 20. The first contact portion 25a1 restricts displacement of the light guide plate 20 in a planar direction toward the LED light source 28 by being in abutting contact with the light entrance surface 20a of the light guide plate 20. The second contact portion 25a2 extends in the thickness direction of the light guide plate 20 with one of side surfaces thereof being in abutting contact with the surface of the LED board 30. The second contact portion 25a2 restricts warp and distortion of the LED board 30 by being in abutting contact with the surface of the LED board 30.

The second restriction portion 25b includes projections 25b1 each having a pointed conical shape. The projections project toward the light exit surface 20a and the opposite surface 20c of the light guide plate 20. Tip ends of the projections 25b1 are caught on the light exit surface 20a and the opposite surface 20c of the light guide plate 20. This restricts the displacement of the light guide plate 20 in a direction perpendicular to the light entrance surface 20a. The third restriction portion 25c includes third contact portions 25c1. The third contact portions 25c1 each extend in the thickness direction of the light guide plate 20 with one of side surfaces thereof being in abutting contact with a surface of the elastic member 19. The spacer member 25 is made of aluminum alloy (having a Young's modulus of 70.3 GPa), for example.

As illustrated in FIG. 4, the elastic member 19 is provided between the LED board 30 and the backlight chassis 22 so as to be in contact with them. A side surface and a bottom surface of the elastic member 19 are bonded to the backlight chassis 22. The elastic member 19 has thermal conductivity. The elastic member 19 is made of silicone rubber (having a Young's modulus of 0.01 to 0.1 GPa), for example. Accordingly, when the spacer member 25 is made of aluminum alloy and the elastic member 19 is made of silicone rubber, the Young's modulus of the elastic member 19 is smaller than that of the spacer member 25.

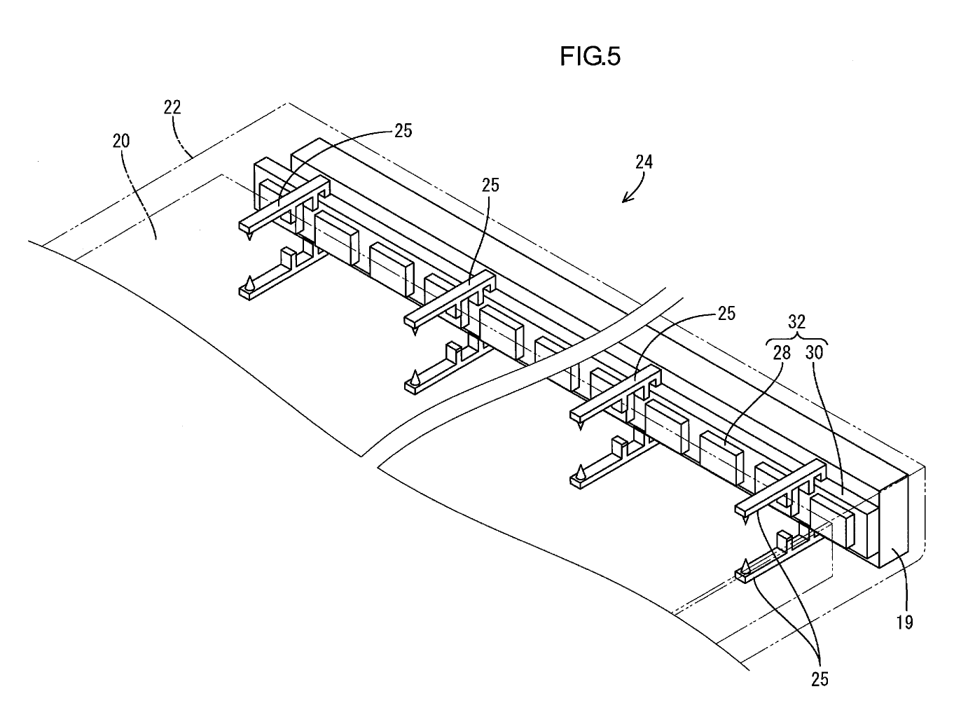

FIG. 5 illustrates a part of the backlight unit 24 in a magnified perspective view. In FIG. 5, the light guide plate 20 and the backlight chassis 22 are transparentized for ease of explanation. As illustrated in FIG. 5, the spacer members 25 are each arranged between the adjacent LED light sources 28 at equal intervals. With this configuration, the light emitted from the LED light source 28 is less likely to be blocked by the spacer member 25. Thus, the light loss is less likely to be caused by the spacer member 25.

The television receiver TV of the present embodiment has been explained in detail. In the backlight unit 24 included in the television receiver TV according to the present embodiment, if the light guide plate 20 is expanded, the first restriction portion 25a1 of the spacer member 25 restricts the displacement of the light guide plate 20 in a planar direction toward the LED light source 28. Further, if the light guide plate 20 is contracted, the second restriction portion 25b of the spacer member 25 restricts the displacement of the light guide plate 20 in a planar direction away from the LED light source 28. Accordingly, the distance between the light guide plate 20 and the LED light source 28 remains constant not only when the light guide plate 20 is expanded by heat but also when the light guide plate 20 is contracted. As a result, the optical design of the backlight unit 24 can be maintained.

If a transparent spacer member is arranged over the entire area between the light guide plate 20 and the LED light source 28, the light emitted from the LED light source 28 passes through the spacer member before entering the light guide plate 20. This may cause a loss of light. In the above embodiment, the light emitted from the LED light source 28 directly enters the light guide plate 20 without passing through the spacer member 25. Thus, a loss of the light is less likely to occur.

In the above embodiment, the first restriction potion 25a of the spacer member 25 includes the first contact portion 25a1 that is in abutting contact with the light entrance surface 20a of the light guide plate 20. The first contact portion 25a1 restricts the displacement of the light guide plate 20 in a planar direction toward the LED light source 28. The second restriction portion 25b of the spacer member 25 includes projections 25b1 each have a pointed conical shape. The projections 25b1 each project toward the light exit surface 20a and the opposite surface 20c of the light guide plate 20. The projections 25b1 are caught on the light exit surface 20a and the opposite surface 20c of the light guide plate 20 so that the displacement of the light guide plate 20 in a direction perpendicular to the light entrance surface 20a is restricted. With this configuration, the displacement of the light guide plate 20 in a planar direction can be properly restricted.

In the above embodiment, the first restriction portion 25a of the spacer member 25 includes the second contact portion 25a2 that is in abutting contact with the surface of the LED board 30. The second contact portion 25a2 positions the surface of the LED board 30 and thus the warp and lifting up of the LED board 30 by heat is less likely to occur.

In the above embodiment, the backlight unit 24 includes the backlight chassis 22 housing the LED board and the light guide plate 20 and the elastic member 19 arranged between the LED board 28 and the backlight chassis 22. The elastic member 19 has a Young's modulus smaller than that of the spacer member 25. Accordingly, if the light guide plate 20 is expanded toward the LED light source 28, the expansion of the light guide plate 20 is absorbed by the elastic member 19 via the spacer member 25. Accordingly, the expansion of the light guide plate 20 can be absorbed and the displacement of the light guide plate 20 in the direction toward the LED light source 28 can be restricted at the same time.

In the above embodiment, the elastic member 19 has thermal conductivity. Heat generated around the LED board 30 can be effectively dissipated by the elastic member 19.

According to the above embodiment, the spacer member 25 includes the third restriction portion 25c that extends from the first restriction portion 25a to the surface of the elastic member 19. The third restriction portion 25c includes the third contact portion 25c1 that is in abutting contact with the surface of the elastic member 19. With this configuration, if the light guide plate 20 is expanded, the expansion of the light guide plate 20 can be directly absorbed by the elastic member 19 without being absorbed by the LED board 30. Thus, the expansion of the light guide plate 20 can be effectively absorbed by the elastic member 19.

In the above embodiment, the spacer member 25 has the linear expansion coefficient smaller than that of the light guide plate 20. Accordingly, the thermal expansion coefficient of the spacer member 25 is smaller than that of the light guide plate 20. Thus, the spacer member 25 can effectively restrict the displacement of the light guide plate 20 in a direction perpendicular to the light entrance surface 20a.

### Second Embodiment

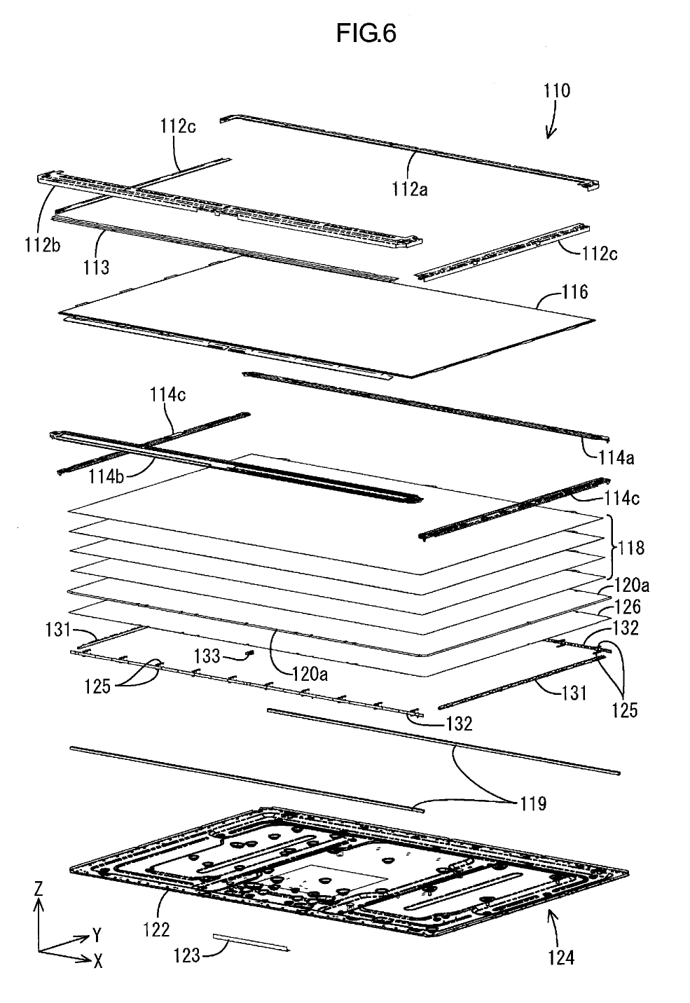

FIG. 6 illustrates a liquid crystal display device 110 according to the second embodiment in an exploded perspective view. An upper side in FIG. 6 corresponds to the front side, and a lower side therein corresponds to the rear side. As illustrated in FIG. 6, the liquid crystal display device 110 has a landscape quadrangular shape as a whole. The liquid crystal display device 110 includes a liquid crystal panel 116 as a display panel and a backlight unit 124 as an external light source. The liquid crystal panel 116 and the backlight unit 124 are integrally held by a top bezel 112a, a bottom bezel 112b, and side bezels 112c (hereinafter, referred to as a bezel set 112a to 112c), for example. The liquid crystal panel 116 has the same configuration as the liquid crystal panel 16 in the first embodiment, and the configuration thereof will not be explained.

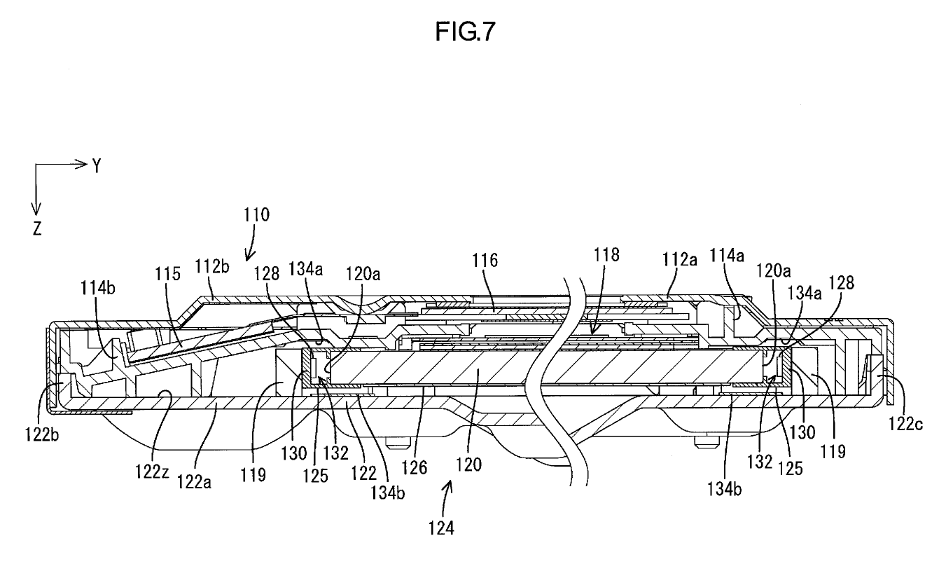

The backlight unit 124 will be explained below. As illustrated in FIG. 6, the backlight unit 124 includes a backlight chassis 122, an optical member 118, a top frame 114a, a bottom frame 114b, side frames 114c (hereinafter, referred to as a frame set 114a to 114c), and a reflection sheet 126. The liquid crystal panel 116 is sandwiched between the bezel set 112a to 112c and the frame set 114a to 114c. An insulating sheet 113 insulates a drive circuit board 115 (see, FIG. 7) that is configured to drive the liquid crystal panel. The backlight chassis 122 has a substantially box-like shape having a bottom and an opening on the front side (the light exit surface side, the liquid crystal panel 116 side). The optical member 118 is provided on the front surface of the light guide plate 120. The reflection sheet 126 is provided on the rear surface of the light guide plate 120. The backlight chassis 122 houses a pair of cable holders 131, a pair of elastic members 119, 119, and a pair of LED units 132, 132, and a light guide plate 120. The pair of elastic members 119, 119 extends along the long-side direction of the backlight chassis 122. The pair of LED units 132, 132 extends along the long-side direction of the backlight chassis 122 and on which the spacer members 125 are mounted. The LED unit 132, the light guide plate 120, and the reflection sheet 126 are supported each other by a rubber bush 133. On a rear surface of the backlight chassis 122, a power circuit board (not illustrated) that supplies power to the LED unit 132, a protective cover 123 configured to protect the power circuit board, and the like are provided. The pair of cable holders 131, 131 extends along the short-side direction of the backlight chassis 122. The pair of cable holders 131, 131 houses wires that electrically connect the LED unit 132 and the power circuit board.

FIG. 7 illustrates the backlight unit 124 in a cross-sectional view. The cross-sectional view in FIG. 7 illustrates a cross-sectional configuration of the liquid crystal display device 110 taken along a Y-Z plane passing through the spacer member 125. As illustrated in FIG. 7, the backlight chassis 122 includes a bottom plate 122a having a bottom surface 122z and side plates 122b, 122c each rising from the outer edge of the bottom plate 122a with a small height. The backlight chassis 122 at least supports the elastic member 119, the LED unit 132, and the light guide plate 120. The light guide plate 120 is arranged between the pair of LED units 132, 132. The light guide plate 120 and the optical member 118 are sandwiched between the frame set 114a to 114c and the backlight chassis 122. The light guide plate 120 and the optical member 118 have the same configuration as those described in the first embodiment, and the configuration thereof will not be explained.

The pair of elastic members 119, 119 each has a rectangular cross-sectional shape. The pair of elastic members 119, 119 is arranged along the respective long side of the backlight chassis 122. A bottom surface of the elastic member 119 is fixed to the bottom plate 122a of the backlight chassis 122. Each of the pair of LED units 132, 132 is fixed on the side surface of the respective elastic members 119 such that the light exit surfaces thereof face each other. Accordingly, the pair of LED units 132, 132 is each supported by the bottom plate 122a of the backlight chassis 122 via the elastic member 119. Further, the elastic member 119 has thermal conductivity, and thus the heat generated on the LED unit 132 is dissipated outside the backlight unit 124 through the bottom plate 122a of the backlight chassis 122.

As illustrated in FIG. 7, the drive circuit board 115 is provided on a front surface of the bottom frame 114b. The drive circuit board 115 is electrically connected to the display panel 116 and is configured to supply image data and various control signals necessary to display the image to the liquid crystal panel 116. Further, the light entrance surface 120a of the light guide plate 120 has an elongated shape. On a portion of a surface of the top frame 114a and the bottom frame 114b exposed to the corresponding LED units 132, a reflector 134a is each provided. The reflector 134a extends along the long-side direction of the light entrance surface 120a of the light guide plate 120. In addition, a reflector 134b is provided on portions of a surface of the backlight chassis 122 that face the corresponding LED unit 132. The reflector 134b extends along the long-side direction of the light entrance surface 120a of the light guide plate 120.

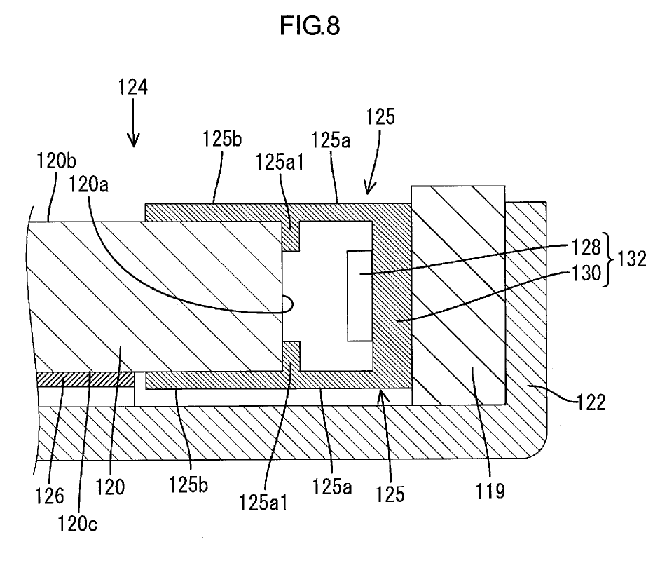

FIG. 8 illustrates the spacer member 125 in FIG. 7 in a magnified cross-sectional view. As illustrated in FIG. 8, in the backlight unit 124 of the second embodiment, the LED board 130 is a part of the spacer member 125. The spacer member 125 includes the first restriction portion 125a and the second restriction portion 125b. The spacer member 125 is capable of reflecting light. The first restriction portion 125a has the same configuration as in the first embodiment, and will not be explained. The second restriction portion 125b extends from the first restriction portion 125a along the light exit surface 120b and the opposite surface 120c of the light guide plate 120 in a direction toward a side opposite to the light entrance surface 120a. The second restriction portions 125b sandwich the light guide 120 in the thickness direction. The displacement of the light guide plate 120 in a direction perpendicular to the light entrance surface 120a is restricted by friction between the light guide plate 120 and the second restriction portion 125b. Accordingly, in the backlight unit 124 of the second embodiment, the displacement of the light guide plate 120 in a planar direction can be more properly restricted.

In the backlight unit 124 of the second embodiment, the LED board 130 is apart of the spacer member 125. With this configuration, the spacer member 125 and the LED board 130 can be molded integrally.

In the backlight unit 124 of the second embodiment, the light entrance surface 120a has an elongated shape. In the vicinity of a space between the LED light source 128 and the light guide plate 120, the reflectors 134a, 134b are provided along the long-side direction of the light entrance surface 120a. The spacer member 125 is capable of reflecting the light. With this configuration, the light emitted from the LED light source 128 and scattered outside the light guide plate 120 can enter the light guide plate 120 by being reflected by the reflector 134a, 134b or the spacer member 125. This improves the light entrance efficiency of the light entering the light guide plate 120 from the LED light source 128.

The configuration of the embodiments correspond to the configuration of the present invention as follows: the LED light source 28, 128 is one example of “light source”; the LED board 30, 130 is one example of “light source board”; the backlight unit 24, 124 is one example of “lighting device”; the liquid crystal display device 10, 110 is one example of “display device”; and the backlight chassis 22, 122 is one example of “housing member”.

The above embodiments may include the following modifications.

(1) In the above embodiments, the LED sources are arranged on the two opposing side surfaces of the light guide plate. However, the LED sources may be arranged on three or all (four) sides of the light guide plate.

(2) In the first embodiment, the projections of the second restriction portion each have a pointed conical shape. However, the projections may have any pointed shape projecting toward the light exit surface and the opposite surface of the light guide plate.

(3) In the first embodiment, the spacer member is fixed to the LED board by bonding. However, the fixation method of the spacer member is not limited thereto. The spacer member may be fixed to the backlight chassis with screws through the LED board and the elastic member, for example.

(4) In the above embodiments, the elastic member is fixed to the backlight chassis by bonding. However, the fixation method of the elastic member is not limited thereto. The elastic member may be fixed to the backlight chassis with screws, for example.

(5) The arrangement, configuration, mounting method of the spacer member are not limited to those described in the above embodiments, and may be suitably changed.

(6) The arrangement, configuration, mounting method of the elastic member are not limited to those described in the above embodiments, and may be suitably changed.

(7) In the above embodiments, the liquid crystal display device including the liquid crystal panel as a display panel is used. The technology can be applied to display devices including other types of display panels.

(8) In the above embodiments, the television receiver including the tuner is used. However, the technology can be applied to a display device without a tuner.

The embodiments of the present invention are explained in detail above, for illustrative propose only, and it is to be understood that the claims are not limited by the forgoing description. The technology described in the claims includes the various modifications of the embodiments described above.

The technology components described in the description and the drawings are not required to be used in the combination described in the claims as originally filed. The technology components can show its technical utility when used either alone or in combination. In addition, the technology described in the above description and the drawings can achieve more than one object at the same time, and the technical utility of the technology can be recognized when the technology achieves one of the objects.

### EXPLANATION OF SYMBOLS

TV: television receiver, Ca, Cb: cabinet, T: tuner, S: stand, 10, 110: liquid crystal display device, 12: bezel, 14: frame, 16, 116: liquid crystal panel, 18, 118: optical member, 18a: diffuser plate, 18b: diffuser sheet, 18c: lens sheet, 18d: reflection-type polarizing plate, 19, 119: elastic member, 20, 120: light guide plate, 20a, 120a: light entrance surface, 20b: light exit surface, 20c: opposite surface, 22, 122: backlight chassis, 22a, 122a: bottom plate, 24, 124: backlight unit, 25, 125: spacer member, 25a, 125a: first restriction portion, 25a1, 125a1: first contact portion, 25b, 125b: second contact portion, 25b, 125b: second restriction portion, 25b1: projection portion, 25c: third restriction portion, 25c1: third contact portion, 26, 126: reflection sheet, 28, 128: LED light source, 30, 130: LED board, 32, 132: LED unit, 112a: top bezel, 112b: bottom bezel, 112c: side bezel, 113: insulating sheet, 114a: top frame, 114b: bottom frame, 114c: side frame, 115: drive circuit board, 123: protective cover, 131: cable holder, 134a, 134b: reflector

1. A lighting device comprising:
a light source board;
a light source mounted on a surface of the light source board;
a light guide plate having a light entrance surface, a light exit surface, and an opposite surface, the light entrance surface being arranged on a side of the light guide plate to face the light source such that light emitted from the light source enters the light entrance surface and exits through the light exit surface, the light exit surface being a plate surface of the light guide plate, the opposite surface being opposite to the light exit surface; and
a spacer member including a first restriction portion and a second restriction portion, the first restriction portion extending between the light source board and a side edge of the light guide plate and configured to restrict displacement of the light guide plate in a planar direction toward the light source, and the second restriction portion extending from the first restriction portion along the light exit surface and the opposite surface in a direction toward a side opposite to the light entrance surface and configured to restrict displacement of the light guide plate in a planar direction away from the light source, whereby the spacer member holds a distance between the light guide plate and the light source board.

2. The lighting device according to claim 1, wherein:
the first restriction portion includes a first contact portion that is in abutting contact with the light entrance surface of the light guide plate, the first contact portion being configured to restrict the displacement of the light guide plate in a planar direction toward the light source; and
the second restriction portion includes pointed projections each projecting toward the light exit surface and the opposite surface of the light guide plate, the projections being caught on the light exit surface and the opposite surface of the light guide plate.

3. The lighting device according to claim 1, wherein:
the first restriction portion includes a first contact portion that is in abutting contact with the light entrance surface of the light guide plate, the first contact portion being configured to restrict displacement of the light guide plate in a planar direction toward the light source; and
the second restriction portion is in abutting contact with the light exit surface and the opposite surface of the light guide plate so as to sandwich the light guide plate in a thickness direction.

4. The lighting device according to claim 2, wherein the first restriction portion further includes a second contact portion that is in abutting contact with the surface of the light source board.

5. The lighting device according to claim 1, further comprising:
a housing member configured to house at least the light source board and the light guide plate; and
an elastic member arranged between the light source board and the housing member, the elastic member having Young's modulus smaller than that of the spacer member.

6. The lighting device according to claim 5, wherein the elastic member has thermal conductivity.

7. The lighting device according to claim 5, wherein:
the spacer member includes a third restriction portion extending from the first restriction portion to a surface of the elastic member; and
the third restriction portion includes a third contact portion that is in abutting contact with the surface of the elastic member.

8. The lighting device according to claim 1, wherein the spacer member has a linear expansion coefficient smaller than that of the light guide plate.

9. The lighting device according to claim 1, wherein the light source board is a part of the spacer member.

10. The lighting device according to claim 1, further comprising a reflector,
wherein the light entrance surface has an elongated shape, and the reflector is arranged in a vicinity of a space between the light source and the light guide plate so as to extend along a long-side direction of the light entrance surface.

11. The lighting device according to claim 1, wherein the spacer member is capable of reflecting light.

12. A display device comprising:
a display panel configured to provide display using light from the lighting device according to claim 1.

13. The display device according to claim 12, wherein the display panel is a liquid crystal panel using liquid crystals.

14. A television receiver comprising the display device according to claim 12.
